(19) United States
(12) Patent Application Publication
(10) Pub. No.: US 2010/0278461 A1
(43) Pub. Date: Nov. 4, 2010

(54) COLLAPSIBLE CUSHION BAG

(76) Inventor: Charles Veiseh, Los Angeles, CA (US)

Correspondence Address: Cislo & Thomas LLP, 1333 2nd Street, Suite #500, Santa Monica, CA, 90401-4110, US

(21) Appl. No.: 12/432,566

(22) Filed: Apr. 29, 2009

(51) Int. Cl. B65D 30/10; B31B 49/04

(52) U.S. Cl. 383/107; 383/105; 493/210

(57) ABSTRACT

A rectangular cushion bag formed from a two-dimensional flat pouch, wherein select portions of the cushion bag comprise a differential rigidity to facilitate transforming the flat pouch into a box-like configuration. The differential rigidity may be created by compromising the bottom corners, strengthening portions of the sealed side edges, weakening portions of the sealed side edges, or any combination thereof. An automated method of creating the cushion bag is also disclosed. In use, the applying a downward force on the bag causes weaker portions of the bag to give way causing the two-dimensional flat pouch to open into a three-dimensional rectangular cushion bag.

### TECHNICAL FIELD

This invention relates to a method for manufacturing a protective liner used to package goods during transport and storage.

### BACKGROUND

A multitude of industries, worldwide, produce and transport goods that are susceptible to damage. Examples of such industries include the electronics, housewares, foods, confections, and industrial goods. Such goods are generally packaged at the plant where they are produced and prepared for shipping to customers or forwarded into a distribution channel.

Containers such as six-sided corrugated boxes are commonly utilized for such packaging of goods. Corrugated containers offer excellent bulk storage characteristics as well as space-efficient collapsibility. Unfortunately, corrugated boxes do not exhibit significant cushioning and/or protective qualities.

A multitude of sheet form materials are utilized in conjunction with such cartons to protect and/or cushion goods that are packaged. Polyethylene bubble, EPE (expanded polyethylene foam) and laminates of the like, are some very common materials utilized to wrap, surround or otherwise protect goods that are packaged in a carton prior to the loading of goods. In addition, it is possible to convert a few of such materials to custom fit or “line” the inside of a carton. EPE and polyethylene bubble are sheet thermoplastic materials that can be cut, heat sealed and converted to conveniently fit the inside dimensions of a carton. Such a combination presents excellent cushioning and fit properties. Thereafter, the liner/carton combination can be loaded with the desired goods. When assembled, such a liner and carton combination offers excellent strength, stackability, shock protection as well as protection from the environment for storage and/or transport.

To ensure a correct fitting, the bottom of the bag or liner should also have a square bottom.

To line a six sided carton with a square bottom bag, a method is needed to convert a selected sheet material into a liner that could properly fit inside.

Such a liner or “bag” is typically made by cutting flexible material into sheets, folding the sheet to form a pouch and thereafter gusseting the pouch to produce a square bottom. Gusseting is important in that it assists in a “squaring” of the bottom of the bag, which significantly improves the fit or “nesting” characteristics of such a bag when placed in a carton.

Gussets can be produced at the bottom of such a pouch by pulling out and folding up the corners, thus converting the single bottom edge into four bottom edges, with the single bottom edge being connected into a centerline parallel to two edges and perpendicular to the other two edges on a previously flat pouch with only two sides. The four “new” edges created on the previously two dimensional pouch allow such a pouch to “open” into a three-dimensional pouch thereby greatly expanding its capacity. When opened and placed on a flat surface, such a converted pouch boasts larger holding volume and will closely resemble the configuration of an open top carton with a square “footprint” that is easy to load with large bulky items.

Importantly, such a pouch can be stored in a folded, space-saving and compact form and opened or expanded by the user when necessary.

There are a multitude of methods whereby such a gusset is made and maintained on a bag or liner. For example, a gusset may be formed by folding and lifting up a triangular portion or pouch at the bottom of the bag. Alternatively, a seal can be made at the base of the gusset in order to preserve it. Another method, namely, the “cut-out” method, is achieved whereby a “blank” of the gusset, i.e., the outline of the area, usually square, where the gusset would embody, is cut out. Thereafter, the pouch is opened, expanded, and the outline of the cut-out area is aligned and brought together in such a way as to produce a straight edge at the bottom corner of the bag. When the straight edge is made, it is sealed together so that the edge is maintained. Such a procedure yields a desired straight edge that is favored in a square bottom bag. The process is repeated at the opposite corner of the pouch. Such methods, especially the sealing of a cut-out area are typically applied to pouches off-line i.e. as a secondary operation, usually manual, on a separate sealing apparatus. This is generally due to the fact that the bag or pouch must be opened for the procedure to occur. Such traditional manual methods are tedious and labor intensive.

Furthermore, while very effective in producing a straight edge and thus a square bottom when applied to a singular pouch, such manufacturing methods do not lend themselves to automation whereby such an automated process of gusseting would be accomplished in-line. Presently, machines that convert plastics into gusseted liners are very common in the plastic bag industry. Typical bags produced by such machines are garbage bags, which are commonly gusseted in-line. Unfortunately, the processes applied to such bags are cumbersome when applied to cushion materials, because the thickness and compressibility of such materials inhibit such processes and produce an end product that is bulky and largely inoperable.

The plastic bag-making process represents a common method by which sheet-form thermoplastics are converted in-line to individual bags. Typically, plastic sheets are folded in-line by v-folding using a “v-Board” and gusseted by a gusset wheel producing an inward “pleat”; a “w” fold. The inward pleat serves as a gusset on the finished bag. Such a process is commonly used to produce gusseted garbage bags. The same process, when applied to cushion materials, and especially to laminates of the like, is cumbersome and often unsuccessful. When cushioned materials are converted as such, they commonly exhibit inconsistent flow, movement and folding characteristics. Furthermore, such converted products made from cushion materials are difficult to use. Folded areas of cushion materials are excessively bulky and several times the thickness of an equivalent item produced with flat plastic sheeting. This yields an end product that is unusually “clumsy” during assembly, as the bags typically do not unfold or “open” properly.

More importantly, flat thermoplastic sheeting, such as that utilized in garbage bags, is “homogenous” i.e. composed entirely of the same materials. Such a material can therefore be sealed together when gusseted in-line because sealing such films is possible on either side. The convoluted folding scenario of in-line automated folding and gusseting via gusset wheel presents many instances where various folds of the web are sealed to one another. In the case of the homogenous plastic film, there is no folding scenario when one layer cannot be sealed to an adjacent layer. When cushioned laminates are utilized, however, such sealing can be problematic. If the laminate material is not of the same chemical nature may be difficult or impossible to heat seal to an adjacent, chemically different side or face of laminate cushion material. Due to such sealing characteristics, gusseted or square bottom bags made from laminated cushion materials or cushion material often, cannot be properly converted utilizing the same methods common to plastic bags.

Therefore, there exists a need for an improved automated method for producing square bottom cushion bags.

### SUMMARY OF THE INVENTION

The present invention describes a three-dimensional rectangular-bottom cushion bag formed from a two-dimensional flat pouch and an improved method of the automated production of the rectangular-bottom cushion bag utilizing cushion material. The cushion bag may be formed by compromising the bottom two corners of a two-dimensional flat pouch or “web form” comprising two mated sheets, reinforcing the sealed edges of the two-dimensional flat pouch, or weakening portions of the sealed edges near the bottom corners.

The present invention takes advantage of the rigidity of cushioned materials, such as enclosed air bubbles, whereby if such bubbles were compromised, destroyed, or punctured in certain portions of a bag, the bag would collapse in desired patterns. Therefore, the aforementioned rectangular-bottom can be accomplished with the “opening” step that mandates a manual process. Specifically, cushion pouches in their “web form” or mated form, i.e. two flat layers or “webs” of material, which, by way of example could be bubble wrap, are unwound from master rolls and sealed along their edges thereby forming a flat, rectangular pouch. Also, the bottom two corners are compromised by destroying the cushioning at the two bottom corners or, at the extreme, cutting the two bottom corners out. Such procedures will facilitate the squaring of an otherwise two dimensional finished pouch, produced from a two dimensional web. One piece of material folded onto itself can also be utilized in the scenario above, wherein the ‘bottom’ of the bag would simply be a fold, and the sides are sealed as above.

Specifically, manipulations to the compromised areas in their flat form will produce characteristics of the finished pouch similar to that when such a pouch is opened and gusseted manually. The flat form of such a pouch opens the door to converting “in-line” when the pouch is still in web form and automation is possible. Again, the “flat web form” can be juxtaposed to the three-dimensional “open” form that often requires a manual process.

In some embodiments, the bottom corners may be compromised in a pattern similar or identical to that utilized in applying a gusset to a pouch in two dimensional form. The plotted pattern, which generally lies at the bottom corners of a finished pouch, is typically rectangular and outlines the area where there is to be a controlled bursting or puncturing of bubbles. Such compromised areas encourage individual pouches to collapse in a manner to produce the desired square or rectangular footprint. Furthermore, an automated process can be applied to the two layer web to produce numerous connected pouches, with compromised areas. The connections between pouches may be perforated so as to be separable from the web and utilized as singular gusseted bags.

To illustrate the mechanics of this method of “in-line” gusseting, note that the relative rigidity of the compromised portion of the flat area is obviously less than the non-compromised portions of the pouch. When an open pouch made with such a process is placed on a flat surface, the weight of the bag and the downward force generated by its weight will encourage collapsing. A controlled collapse will occur, whereby the two compromised bottom corners will “cave in,” producing two relatively straight edges. Unlike the two corners, the remaining body of the bag, with bubbles intact, will remain relatively rigid and erect.

Therefore, such individual pouches, when opened and placed on a flat surface will effectively nest in the bottom of a square carton as they tend to collapse in the proper pattern.

Such a procedure can be achieved while the web is in a two dimensional or flat form. As a result, the compromising process can be “in-line” on a special pouch machine that processes a web, which automates the process of flattening. Additionally, such a design does not produce the bulky and often inoperable seals produced with a gusset wheel or the like. Such a process can also be applied to individual pouches made of such materials off-line, i.e one at a time, which, although still considered a manual operation, is typically a more rapid production method.

In some embodiments, cushion material can be converted to a square bottom pouch by reinforcing the sealed side edges. Again, a two layer web of cushion material can be converted to pouches by sealing the layers together at the edges. Such a configuration can be individually cut thereafter producing singular pouches. A variation of such a process can be utilized in the scope of the invention whereby the two “seams” or side seals can be favorably reinforced while the pouch is being converted or sealed in-line. Thereafter, such reinforcement can be effectively utilized on a finished pouch when it is produced from the two layer web of cushion film. The side seals of the two-dimensional pouch later serve as the vertical seams of the finished bag when held upright. Such seams can act as a “vertical stems” in a finished bag.

In order to encourage the desirable “controlled collapse” producing a rectangular bottom, the side seals above the compromised area can be can be selectively reinforced or strengthened via thermoforming into strong and relatively rigid “stems” in selected areas. In some embodiments rigid strips may be inserted between the seams. The seam area adjacent the compromised area is not manipulated as such so that it remains weak relative to the remaining side seal above. This, when present in a cushion bag that is on a flat surface, such as the bottom of a carton, further allows a selective collapse of the un-strengthened areas of the side seal. The strengthened or reinforced seal areas are less likely to fold than the un-strengthened seal and such a scenario when coupled with the downward weight of the bag encourages a folding of the compromised area of the bag and thus a straight edge at the bottom. Strengthening the seal not only facilitates the controlled collapse so as to form the rectangular bottom, but it also allows the bag to maintain an upright or erect posture to facilitate loading the bag.

In some embodiments, the method of strengthening such a seam can be achieved by curling or bending the seam, which can be accomplished in-line. “Curling,” which has the equivalent as “bending” for the purposes of this patent, can be accomplished during forming of the said seal utilizing a thermoforming method accomplished by applying a heated wheel-like thermoformer or curved or angled sealing head which shapes the seal in a semi-circle, concave, angled or convex fashion. For the purposes of this patent, “curling” or “curled” represents any shape applied that creates a resistance to bending. This is further illustrated wherein the two layers of cushion film are run under a sealing head that runs along the length of the web. When the desired shape is achieved it is cooled while held in that configuration. Thereafter, the seal will remain curved and will serve as a fortified vertical seal on the individual square bottom bag.

Closely observed, such a seal boasts the excellent rigidity and strength of a curved shape in addition to the fortitude of multiple layers of compressed plastics. This provides a higher resistance to bending than if the seal were flat. On the finished bag, when such a strengthened “stem” is used in conjunction to a relatively weak portion of the stem adjacent to the “flat area”, the desired “controlled collapse” is yielded. There are other methods of strengthening such a seal area, namely applying adhesives or the like in-line to achieve more rigidity. The “stem curling” method may be improved by using it in conjunction with the “stem trimming” method discussed below.

Furthermore, such a process can be accomplished with bubble or cushion materials made of thermoplastics such as polyethylene. Such materials boast moldability as they can be readily shaped when heated to melting temperatures of approximately 220° F. When the desired shape is achieved, the materials can be cooled while maintaining their form. Heavier gauges of cushion material tend to be more readily shaped and also more likely to retain their shape, as they present a greater mass of material to be manipulated. Also, where laminate materials such as metalized polyester, paper, or aluminum are used, they have an additional benefit of much higher melting points than the polyethylene bubble to which they are laminated. Therefore, when extreme heat and melting occur, the laminate material better retains its integrity and form. Thus, laminate materials act as a sort of “shell” to the inner plastic material in molten form. Such a shell encourages uniformity, intactness and thus containment, while materials such as polyethylene are in softened molten form, allowing it to be shaped as desired without drool or uncontrollable expansion. The material can then be cooled when in the desired shape, thereby preserving the form.

When such laminate materials are utilized to produce square bottom pouches, the stem can be easily fortified or strengthened using a heating, forming and cooling process of the side seams of the pouch. Such a process can be applied to individual pouches automatically or ‘in-line,’ which avoids the need to “open” the pouch manually after completing the in-line process.

In some embodiments, to achieve a 4-sided bottom, the side seal adjacent the compromised area may be “weakened” or trimmed. Such weakening can be accomplished via shredding, hole punching or trimming the seal at the collapsible area adjacent the compromised bottom corners. These processes can be accomplished with careful timing and correct positioning of the weakening apparatus so that they are applied on the desired area on a web. Such cutting action, when applied to a seal, inherently weakens or destroys its rigidity. Furthermore, since seals applied to thermoplastics are generally multi-ply, producing a hard and relatively rigid seal, the destruction of such a seal will produce a void in its rigidity. Such cutting makes such a seal area more crushable and collapsible relative to the rest of the seal. Importantly, this process too can be applied to a two layer web in-line. When the seal applied to the webs is “exaggerated” or larger, it tends to provide a more pronounced and more rigid side seal on the bag. Conversely, when the seal is selectively weakened, it provides for more efficient selective folding.

Furthermore, the aforementioned methods of producing such square bottom cushion bags may be applied to the “fold up method” of production whereby a triangular pouch is formed and folded up to create the bottom edge of a square bottom bag. Certain methods can yield such folding behavior while in-line. While using the stem reinforcing or weakening techniques, attention is given to the base of the fold i.e. the bottom of the triangular gusset to be formed at a spot on the top edge of the compromised area of a flat pouch. The bottom also serves as the inside edge of the square bottom bag to be formed. Such a bottom is the fold point of the gusset, this fold point can facilitate the “controlled collapse” by acting as a bending point for the triangular pouch. This process can be accomplished “in-line” on a two layer web, whereby the same cannot typically be accomplished on the individual bags.

Although not always a perfect square bottom, the described process generally produces a straight edge or a favorable collapse at the bottom of the bag and/or a form that can be effectively “nested” inside an outer square bottom box.

The aforementioned processes are also applicable to any flat, individual pouch, as opposed to two layered flat webs. While this does not offer the advantages of automated methods of production, it does present a faster and easier method to produce a square bottom on a pouch. Common thermoplastic products such as polyethylene foam cushion can be utilized in place of bubble film, as they too contain trapped air bubbles that can be burst or crushed.

The collapsible cushion bag described herein can be produced from any flexible cushioned material and the methods described, namely compromising the integrity of portions of the pouch, reinforcing seals, and weakening seals, and the various manipulations illustrated above can be utilized alone or in any combination thereof. Also, the aforementioned controlled collapse that is facilitated by the various processes described represents a more self-contained version of ‘squaring and opening’ that requires little to no intervention by the user. The controlled collapse created by the process described herein is simply one method of producing the square bottom or straight edge. The same processes described above can be utilized to produce a straight edge whereby the user of the pouch simply pulls the sides of the pouch outward in a direction parallel to the area of the future edge when applied at or above the desire compromised area. The compromised area, reinforced seal, and weakened seal methods all work effectively to encourage a straight edge at the bottom of a pouch when combined. Therefore, the user need not place the pouch on a flat surface to produce a square bottom, the user can also pull out the corners as described and such an action will effectively produce a desired straight edge in a controlled and measured fashion.

Furthermore, the processes described can also be utilized to produce many bags that are on a roll and ready for dispensing i.e. the bags can be perforated and individually cut-off the roll for use. This scenario presents additional space savings due to the high space efficiency of rolled goods.

In some embodiments, the flat pouches may be scored to outline the area to be compromised. In addition, multiple score lines may be used throughout the pouch to adjust size of a bag.

### BRIEF DESCRIPTION OF DRAWINGS

FIG. 1 shows a perspective view of an embodiment of the invention in a flattened configuration;

FIG. 2 shows a perspective view of an embodiment of the present invention in an opened configuration;

FIG. 3 shows a front view of a process for making the invention;

FIG. 4 shows a side view of a process for making the invention;

FIG. 5 shows a perspective view of another embodiment of the present invention in the flattened configuration;

FIG. 6 shows a perspective view of another embodiment of the present invention in the flattened configuration; and

FIG. 7 shows a perspective view of another embodiment of the process for making the invention.

### DETAILED DESCRIPTION OF THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

The collapsible cushion bag of the present invention is a flat compact cushion bag that quickly and easily opens in the shape of a box to provide padding and/or insulation to products shipped in a box. The collapsible cushion bag is analogous to a traditional flat cushioned mailer or padded envelope, size limitations notwithstanding, and, therefore, can be stored and transported efficiently.

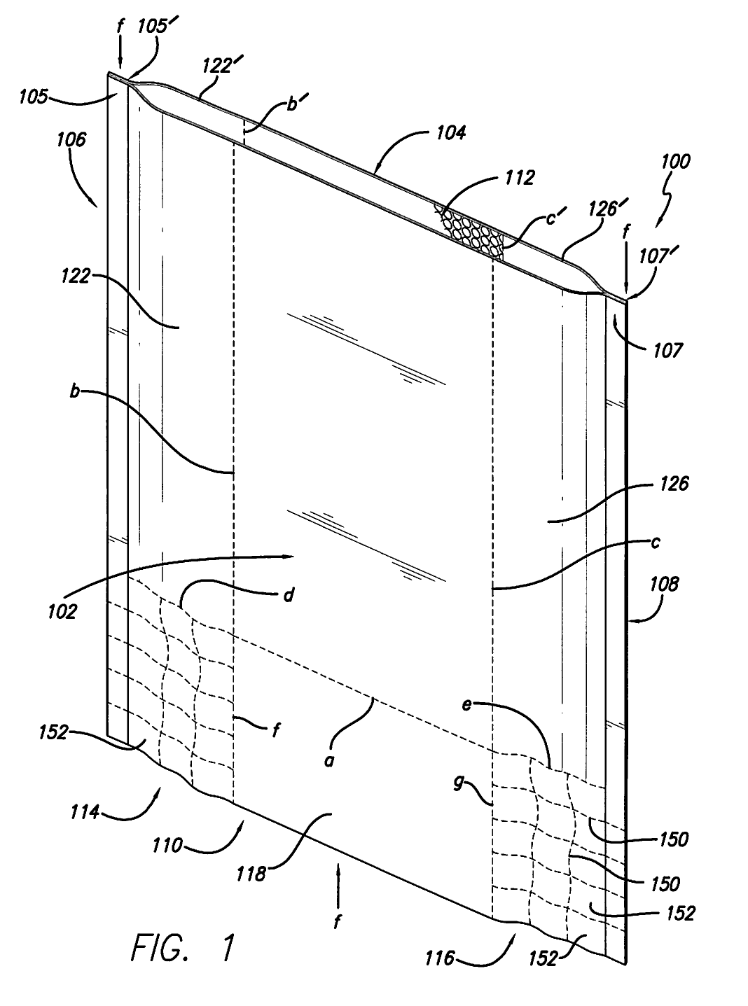

Referring to FIG. 1, the collapsible cushion bag 100 comprises a first side 102; a second side 104 opposite the first side 102; a first sealed edge 106 forming a first “stem”; a second sealed edge 108 opposite the first sealed edge 106 forming a second “stem”; a closed bottom edge 110 adjacent to the sealed edges 106, 108; and a top opening 112 opposite the closed bottom edge 110 and adjacent to the sealed side edges 106, 108, thereby forming, in general, a rectangular shape, which by definition also includes a square shape. Unlike traditional mailers or padded envelopes or bags, in the present invention, select portions of the cushion bag 102 may comprise a differential rigidity relative to remaining portions of the cushion bag 102.

The differential rigidity in select portions of the bag can be achieved in a number of different ways. For example, the integrity of portions of the two bottom corners 114, 116 may be compromised such that the integrity of the bottom corners 114, 116 are destroyed, weakened, or removed relative to the remainder of the bag 100. In another embodiment, the differential rigidity may arise at the sealed edges 106, 108. For example, portions of the sealed edges may be strengthened. Alternatively, portions of the sealed edges may be weakened. Other portions of the bag 100 besides the sealed edges can also be selectively reinforced or strengthened. These techniques can be used alone or in any combination to create the differential rigidity relative to the respective adjacent portions of the bag 100.

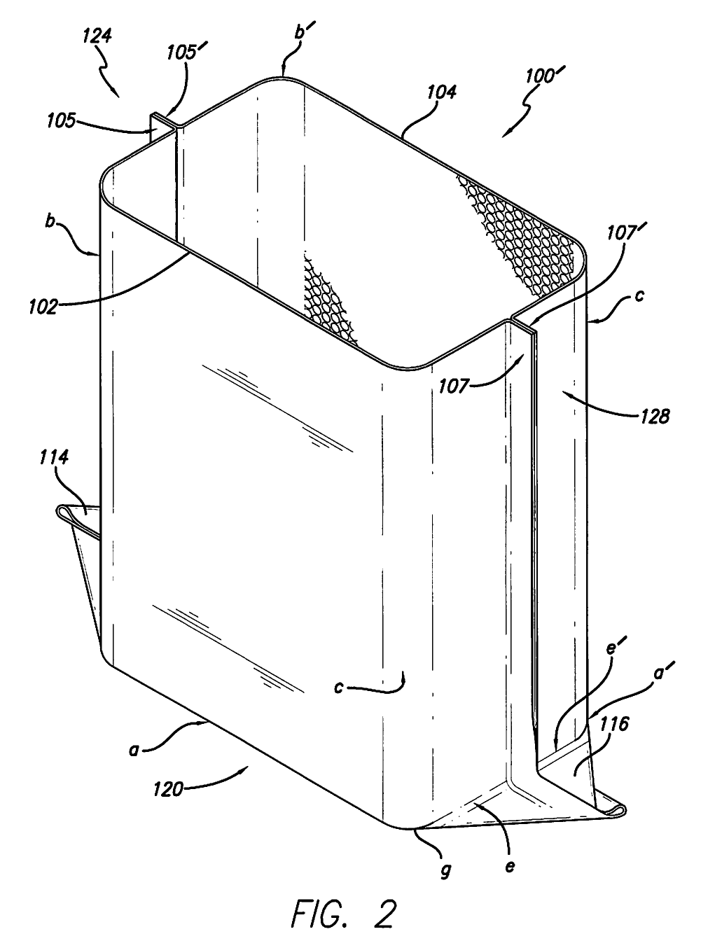

Compromising the two bottom corners 114, 116 allows the compromised bottom corners 114, 116 to collapse when a force f is applied to the two sealed side edges 106, 108 and an opposing force f′ is applied to the bottom edge 110. For example, placing bottom edge 110 of the bag 100 on a flat surface and applying a downward force f on the side edges 106, 108 creates an upward and opposing force f′ on the bottom edge 110, wherein the bottom edge 110 moves toward the top opening 112. This causes the first and second sides 102, 104 to move away from each other, wherein bottom portions 118, 118′ of the first side 102 and second side 104 bend at a, a′ to form a flat bottom 120, first side portions 122, 122′ of the first and second sides 102, 104 bend at b, b′ to form a third side 124, and second side portions 126, 126′ of the first and second sides 102, 104 bend at c, c′ to form a fourth side 128 opposite the third side 124, thereby forming a rectangular bag 100′ as shown in FIG. 2.

In some embodiments, once the box-like configuration has been formed, the bottom of the third and fourth side 124, 128 may be sealed to the flat bottom 120 or simply folded up or down without any sealing. In other words, the folded portions at d and e may be sealed to the folded portions at f and g, respectively, to maintain the box-like configuration. The seal may be along the inside or the outside of the cushion bag 100 or along the base of the fold. The seal may go across the entire width of the bag 100 or only portions of the bag 100. The folded area may also be cut-out and sealed subsequent to removal.

The rectangular cushion bag 100′ is now configured to fit efficiently inside a rectangular box of the appropriate dimensions. The final dimensions of the collapsible cushion bag 100 are determined by the size of the compromised bottom corners 114, 116 as can be determined by a person of ordinary skill in the art.

Compromising the first and second bottom corners 114, 116 can be accomplished by a variety of means from weakening the integrity of the bottom corners 114, 116, to completely removing the bottom corners 114, 116. In some embodiments, bottom corners 114, 116 can simply be weakened by cutting, popping, crushing, perforating or otherwise destroying the integrity of the bottom corners 114, 116 and/or, in the case of air bubble-type cushions, the ability of the air bubbles to hold air in the bottom corners 114, 116. For example, in cushion bags utilizing air-filled bubbles, such as Bubble Wrap®, the bubbles may be popped by crushing or piercing the bubbles. Crushing the bubbles allows the crushed area to crumple under pressure or stress, while intact portions remain sturdy.

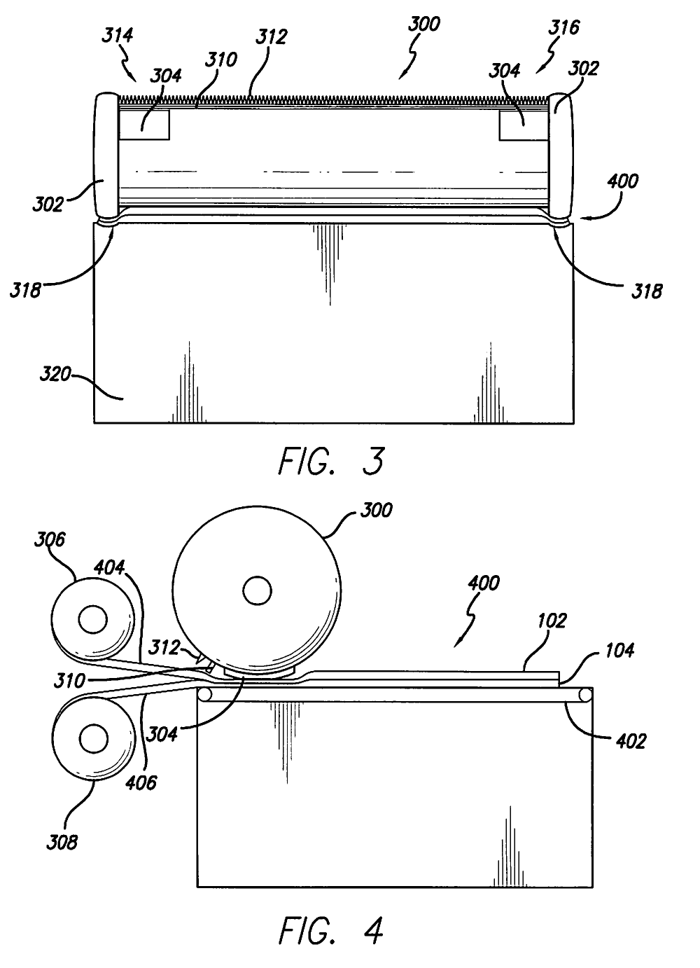

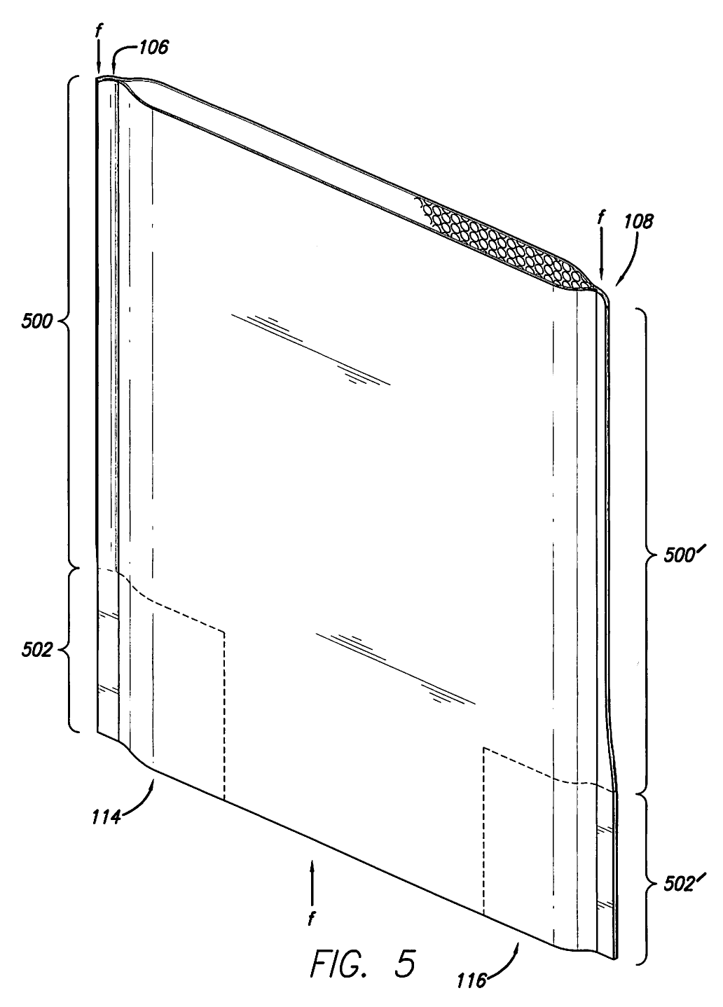

The bottom corners 114, 116 can be crushed in a variety of ways, for example, manually or automatically under a modified roller 300 as shown in FIGS. 3 and 4 or a press 700 as shown in FIG. 7. In some embodiments, a roller 300 comprising a pair of sealers 302 and a pair of tools 304 may be positioned just above a mated pair of sheets 400 at a height that is substantially similar to the thickness of the mated pair of sheets 400 to roll over the mated pair of sheets 400 as shown in FIGS. 3 and 4. The sealers 302 located at the lateral edges 314, 316 of the roller 300 may have a diameter greater than the diameter of the roller 300, thereby sealing the mated pair of sheets 400 at the edges to form the bag. The tools 304 may also be located at the lateral edges 314, 316 of the roller 300 but just interior or medial to the sealers 302 to intermittently compromise the integrity of the bottom corners 114, 116.

In some embodiments, the tool 304 may be a solid rectangular plate. Since the plate adds thickness to the roller's 300 diameter the plate decreases the gap between the roller 300 and the platform 320 to less than the thickness of the mated sheets 400, thereby crushing the mated sheets 400 as the plate rolls on to the mated sheets 400. If the mated sheets 400 contained Bubble Wrap®, the bubbles would be popped, thereby destroying the integrity of the bottom corners 114, 116. In some embodiments, the plates can have sufficient thickness and sharpness so as to cut the bottom corners 114, 116 off completely.

The tools 304 can be any other type of device that can compromise or destroy the integrity of the cushions, such as plates, needles, rollers, blades, blunt objects, and the like.

In some embodiments, the tool 304 may be blades located at each of the lateral edges 314, 316 of the roller 300. In some embodiments, each of the lateral sides 314, 316 may comprise a pair of blades arranged perpendicularly to each other to outline the bottom corners 114, 116 to be compromised. In some embodiments, the bottom corners 114, 116 may be scored, perforated, or otherwise outlined to define selectively compromiseable sections 152 that can be compromised independently of one another at a later time. In some embodiments, the tool 304 may be a plurality of blades to score or perforate the bottom corners 114, 116 into a plurality of perpendicular score lines 150. Since the dimensions of the bottom corners 114, 116 determine the overall size of the opened bag, the user can selectively compromise small compromiseable sections 152 from each corner 114, 116 until the proper dimensions have been compromised. In some embodiments, the compromiseable sections 152 may be labeled so that the user knows which compromiseable section 152 to compromise in order to get a bag of the desired dimensions. Preferably, the compromiseable sections 152 are rectangular in shape; however, any shape can be used, such as triangles, circles, semi-circles, parallelograms, and the like.

To automate the system, the first and second sheets 102, 104 may be pulled off a pair of rolls 306, 308 onto a conveyor belt 402. The resistance created by the roller 300 on the mated sheets 400 is sufficient to pull the sheets off the rolls 306, 308. The circumference of the roller 300 is equal to the length of the sheets 102, 104. The roller 300 may further comprise a bottom sealer 310 and a perforator 312. The roller 300 pushes the mated sheet from the top end 112 to the bottom end 110 while sealing the side edges 106, 108. As the roller 300 reaches the bottom end of the mated sheet 400, the tool 304 compromises the integrity of the bottom corners 114, 116, then the bottom sealer 310 seals the bottom edge 110. Finally, a perforator 312 creates a perforation between the bottom 110 of the first bag and the top 112 of a second bag. When the first bag is torn from the second bag, the bottom edge 110 of the first bag remains sealed while the top end 112 of the second bag becomes opened.

In some embodiments or methods, a press 700 may be used to compromise the integrity of the bottom corners 114, 116. As shown in FIG. 7, the press 700 may comprise a pair of tools 304 positioned bilaterally relative to the conveyor belt 402 so as to line up with the bottom corners 114, 116 of the bag. Once the bottom corners 114, 116 align with the press, the press can compromise the bottom corners 114, 116.

In some embodiments, the first and second sheets 102, 104 can be sealed, then have the bottom corners 114, 116 compromised. In some embodiments or methods, the press 700 may comprise both the sealer 302 and the tool 304, to seal the edges 105, 105′ and 107, 107′ and compromise the bottom corners 114, 116 simultaneously. The press could also be used to overseal, curl, truncate, and/or incorporate a stiffener into the seals as described elsewhere in this specification, either in combination with or in lieu of compromising the bottom corners by crushing/perforation or the like. In yet another embodiment or method, the press 700 may comprise the sealer 302, the tool 304, and the perforator 312, to seal the edges 105, 105′ and 107, 107′, compromise the bottom corners 114, 116, and provide a tear-off perforation, simultaneously. In any of these press embodiments or methods, the press could be equipped with a bottom sealer 310, which could seal the bag simultaneously with the other processes or separately. In any of these press methods or embodiments, the material can be moved though the press by rollers, conveyor belts, or by attaching the first finished bag to a take-up reel that pulls the material through the press, or any combination thereof, or any other method to move web material through a press known to those skilled in the art.

The edges may be sealed by heat, RF, glue, sealants, or other suitable sealing methods. Again, the mated sheets 400 may be placed on a conveyor belt 402 to automate the system. Commercially available pouch and bag machines, such as those offered by RO-AN and Hudson-Sharp, among others, may be modified to implement the sealing and compromising methods described herein. Such machines typically use either continuous web rolling operation as described in previous paragraphs, or intermittent press operation (where the web is stopped intermittently while the press operates), as described by this paragraph. Intermittent press machines may have an advantage over continuous roll operation machines by being easier to change the configuration of the cushion bags being produced. For example, the length of the bag may be changed by simply altering the length of the material fed into the press, without necessarily changing the press die. Typically, dies may be more easily changed than rollers to alter the compromised areas and the seals. These advantages could be useful where a manufacturer produces many different size bags on a single machine.

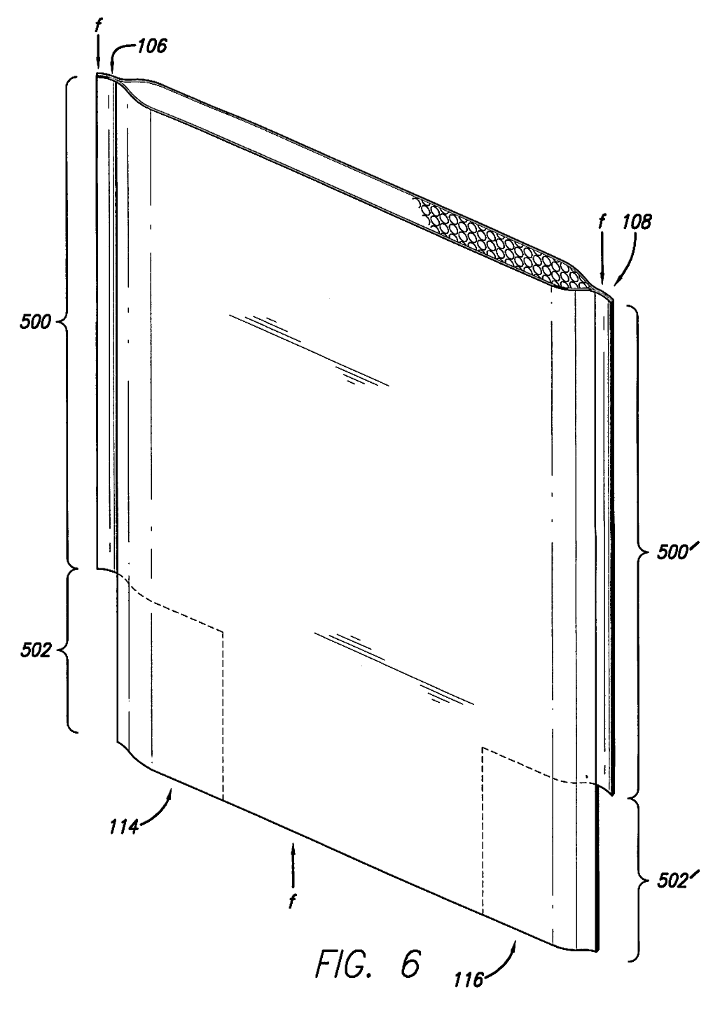

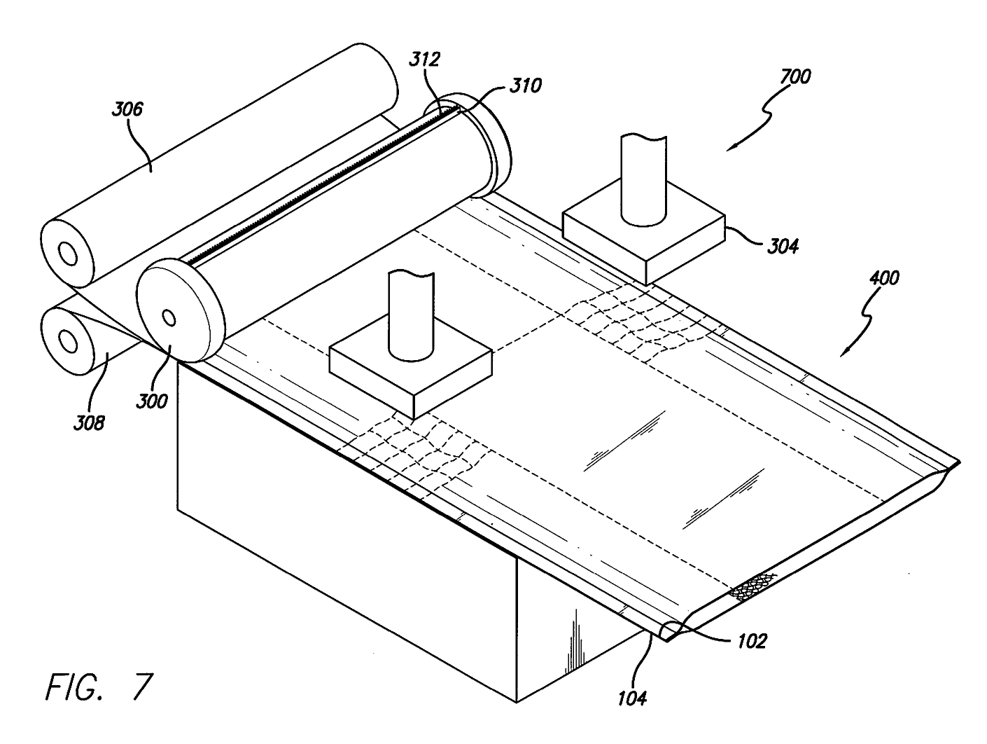

As shown in FIGS. 5 and 6, in some embodiments, to facilitate the box-like formation of the cushion bag 100, the sealed edges 106, 108 may comprise the differential rigidity, wherein at each sealed edge 106, 108, a first portion 500, 500′ of the sealed edge 106, 108 has a rigidity different than a second portion 502, 502′ of the sealed edge 106, 108. In particular, the first portions 500, 500′ of the sealed edges 106, 108 may have a rigidity that is greater than the second portions 502, 502′ of the sealed edge 106, 108. This relatively greater rigidity of the first portions 500, 500′ allows the first portions 500, 500′ to maintain integrity while a force f is applied to them while the second portions 502, 502′ succumb to the force f.

The differential rigidity between the first portions 500, 500′ and the second portions 502, 502′ of the sealed edge 106, 108 may be created by a variety of techniques. In some embodiments, sealed edges 106, 108 may be strengthened or reinforced. For example, the first portions 500, 500′ of edges 106, 108 may be sealed using a curled seal as shown in FIG. 5. A curled seal may be created by positioning the edges 106, 108 over a curved well 318 and pressing or rolling a curved sealer 302 or the curved portion of a sealer 302 into the well with the edges 106, 108 sandwiched in between as shown in FIG. 3. In some embodiments, the sealer 302 may be wedge-shaped or have wedge shaped portions and the well 318 may be reciprocally wedge-shaped so as to form bent seals. In some embodiments, the sealer 302 may be any other substantially non-flat shape or may have any other substantially non-flat portions to create deformations in the sealed edges 106, 108 that strengthens the vertical rigidity of the sealed edges 106, 108. In some embodiments, the sealed edges 106, 108 may be reinforced by sealing a stiff material, such as a strip of plastic, in between the first portions 500, 500′ of the sealed edges 106, 108.

In some embodiments, the differential rigidity may be created by weakening the second portions 502, 502′ of the sealed edges 106, 108. For example, the seal at the second portions 502, 502′ of the sealed edges 106, 108 may be trimmed or shaved off so as to be truncated and made thinner, or otherwise, weakened relative to the first portions 500, 500′, as shown in FIG. 6. This loss of material weakens the rigidity of the edge at the second portion 502. Relatively speaking, this then creates an overseal in the first portions 500, 500′.

In some embodiments, rather than truncating the second portions 502, 502′, the first portions 500, 500′ may be oversealed, meaning more of the side edges 105, 105′, 107, and 107′ are sealed in the first portions 500, 500′ relative to the second portions 502, 502′. The seals can be formed anywhere along the first and second sides 102, 104 so long as a bag configuration is formed.

The differential rigidity involving stem strengthening or stem weakening may be formed anywhere along the bag 100 and not necessarily at the side edges 105, 105′, 107, and 107′. In addition, each of the techniques for creating a differential rigidity can be utilized in any combination.

In some embodiments utilizing the compromised bottom corners 114, 116 and stem weakening and strengthening techniques, the second portions 502, 502′ of each sealed edge 106, 108 are directly below their respective first portions 500, 502, and immediately adjacent to their respective compromised bottom corner 114, 116 as shown in FIG. 6, thereby facilitating the collapse of the cushion bag 100. In other words, the compromised bottom corners 114, 116 may be bound to the respective second portions 502, 502′ and portions of the closed bottom edge 110. Therefore, the first side 102 and the second side 104 of the cushion bag 100 have a first rigidity, and the first bottom corner 114 and the second bottom corner 116 have a second rigidity, wherein the first rigidity is greater than the second rigidity, and wherein the first and second sealed edges 106, 108 each have a first portion 500, 500′ having a third rigidity, and a second portion 502, 502′ having a fourth rigidity, wherein the third rigidity is greater than the fourth rigidity, and wherein the second portions of the first and second sealed edges are immediately adjacent to the first and second bottom corners, respectively, whereby application of a force f on the sealed side edges 106, 108 towards the closed bottom edge 110 results in the formation of a box-like configuration.

Typical cushion materials used in packaging are plastic bubble film as well as bubble film laminates. Laminates such as metalized polyester provide tear resistance as well as product protection. The bubbles in such laminate/cushion combinations create rigidity in the body of the material and such rigidity is carried over into converted products such as pouches. Furthermore, materials and therefore pouches made with such materials display “standing” capability due to the rigidity of such material whereby the material remains at least briefly vertical when such a pouch is held upright. A majority of such rigidity often lies in the air cushion bubbles they contain.

Thus, the present invention also encompasses a method of manufacturing a collapsible cushion bag 100, comprising mating a first rectangular sheet portion 102 to a second rectangular sheet portion 104; sealing a first side edge 105 of the first rectangular sheet 102 to a first side edge 105′ of the second rectangular sheet 104 to form a first sealed side edge 106; sealing a second side edge 107 of the first rectangular sheet 102 to the second side edge 107′ of the second rectangular sheet 104 to form a second sealed side edge 108, sealing a bottom edge of the first rectangular sheet with a bottom edge of the second rectangular sheet, thereby forming a bag 100 having a top opening 112 and a closed bottom 110, the bag 100 defining a first bottom corner 114 and a second bottom corner 116; and compromising a portion of each bottom corner 114, 116, wherein the collapsible cushion bag is formed.

The sealing step comprises providing a sealing platform 320 or 402 comprising two curved seal areas 318, each curved side well operatively associated with a curved sealer 302; and placing the mated sheet 400 on the sealing platform 320 or 402, wherein the first side edges and the second side edges are in between their respective seal areas 318 and their respective curved sealers 302; rolling the curved sealers 302 through their respective curved seal areas 318 on top of their respective first and second side edges of the sheets, thereby creating a curved seal at the first and second side edges 106, 108.

The method may further comprise strengthening or weakening a portion of the first and second sealed edges, 106, 108, each weakened portion being adjacent to one of the compromised bottom corners 114, 116.

In some embodiments, the closed bottom 110 is formed by sealing a bottom edge of the first rectangular sheet portion 102 to a bottom edge of the second rectangular sheet portion 104. A perforated attachment may be created between the first and second mated rectangular sheet portions 102, 104 and a third and fourth mated rectangular sheet portions 404, 406, wherein tearing the perforated attachment creates the top opening of the bag formed by the third and fourth mated rectangular sheet portions 404, 406.

In some embodiments, collapsible cushion bag 100 may be made from a single roll 306. Thus, the first and second sheets 102, 104 may be opposite portions of the same sheet. A sheet may be pulled from the single roll 306 and folded in half to form the first and second sheet portions 102, 104 that are to be mated, while automatically creating a closed bottom 110. The side edges 105, 105′, 107, and 107′ can be sealed as described above and the bottom edge would already be sealed, thereby eliminating the sealing step for the bottom edge 110.

In addition to embodiments where the seams are located on each side of the bag, in other embodiments the seams could be located elsewhere on the bag. For example, in form, fill, and seal machines, such as those used to package potato chips, a single roll of material is used as a web and the seam is placed in the center of the bag (on potato chip bags, this seam is found in the center of the back of the bag), while the top and bottom are sealed. In similar machines that create seals on three sides, a single roll of material is used, but the seam is placed on the side of the bag, while the top and bottom are also sealed. There are numerous manufacturers of such machines, including Triangle Package Machinery Company and General Packaging Equipment Company. When used to produce a collapsible cushion bag that is not immediately filled, the top would be left unsealed. In either type of machine, when used to produce a collapsible cushion bag, a step could be added during the sealing process to compromise the areas of the bag necessary to achieve the selective collapse at the sides of the bag. The apparatus to achieve the compromising of the bag would be similar to that described above. In addition, the single side seam could be manipulated during the sealing process or afterwards, as described above, to provide the necessary rigidity to hold the bag in the proper position during placement or filling.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

### INDUSTRIAL APPLICABILITY

This invention may be industrially applied to the development, manufacture, and use of cushion bags for the purpose of improving the efficiency of manufacture, storage, transport, and assembly of the cushion bags without compromising its ability to insulate and pad the transported products. The invention comprises two cushioned sheet portions sealed together to form a flat rectangular bag having compromised bottom corners to facilitate formation of a box-like bag. The edges may further comprise a differential rigidity.

What is claimed is:

1. A collapsible cushion bag, comprising:
a. a first side;
b. a second side opposite the first side;
c. a first sealed edge;
d. a second sealed edge opposite the first sealed edge;
e. a closed bottom edge adjacent to the first and second sealed edges;
f. a first bottom corner bounded by portions of the first sealed edge and the closed bottom edge;
g. a second bottom corner bounded by portions of the second sealed edge and the closed bottom edge;
h. an opening opposite the closed bottom edge and adjacent to the first and second sealed edges,
i. wherein the first side and the second side of the cushion bag have a first rigidity, and the first bottom corner and the second bottom corner have a second rigidity, wherein the first rigidity is greater than the second rigidity, and
j. wherein the first and second sealed edges each have a first portion having a third rigidity, and a second portion having a fourth rigidity, wherein the third rigidity is greater than the fourth rigidity, and wherein the second portions of the first and second sealed edges are immediately adjacent to the first and second bottom corners, respectively, to form a box-like configuration.

2. The collapsible cushion bag of claim 1, wherein each of the first portions of the first and second side sealed edges comprises a curved seal.

3. The collapsible cushion bag of claim 1, wherein each of the first portions of the first and second side sealed edges comprises an overseal.

4. A collapsible cushion bag, comprising:
a. a first side;
b. a second side opposite the first side;
c. a first sealed edge;
d. a second sealed edge opposite the first sealed edge;
e. a closed bottom edge adjacent to the first and second sealed edges; and,
f. an opening opposite the closed bottom edge and adjacent to the first and second sealed edges, wherein select portions of the cushion bag comprise a differential rigidity.

5. The collapsible cushion bag of claim 4, wherein a first and second differential rigidity is generated by compromising a first bottom corner and a second bottom corner, respectively, to weaken the first and second bottom corners relative to respective adjacent portions of the cushion bag.

6. The collapsible cushion bag of claim 5, wherein a third and fourth differential rigidity is generated at each of the sealed edges, wherein in each sealed edge, a first portion of each sealed edge is more rigid than a second portion of each sealed edge.

7. The collapsible cushion bag of claim 6, wherein each of the first portions of the first sealed edge and the second sealed edge is reinforced.

8. The collapsible cushion bag of claim 6, wherein each of the first portions of the first sealed edge and the second sealed edge comprises a curled seal.

9. The collapsible cushion bag of claim 6, wherein each of the first portions of the first sealed edge and the second sealed edge comprises an overseal.

10. The collapsible cushion bag of claim 6, wherein each of the second portions of the first sealed edge and the second sealed edge is weakened.

11. The collapsible cushion bag of claim 10, wherein each of the second portions of the first sealed edge and the second sealed edge are trimmed.

12. The collapsible cushion bag of claim 6, wherein each of the second portions of each sealed edge is adjacent to their respective compromised bottom corner.

13. The collapsible cushion bag of claim 4, wherein the differential rigidity is generated by reinforcing the select portions of the cushion bag.

14. The collapsible cushion bag of claim 13, wherein the select portions of the cushion bag comprise a curled seal.

15. The collapsible cushion bag of claim 13, wherein select portions of the cushion bag comprise an overseal.

16. The collapsible cushion bag of claim 4, wherein a first bottom corner and a second bottom corner each comprises a plurality of compromiseable sections.

17. The collapsible cushion bag of claim 4, wherein the differential rigidity is generated at each of the sealed edges, wherein in each sealed edge, a first portion of each sealed edge is more rigid than a second portion of each sealed edge.

18. The collapsible cushion bag of claim 17, wherein each of the first portions of the first sealed edge and the second sealed edge is reinforced.

19. The collapsible cushion bag of claim 17, wherein each of the first portions of the first sealed edge and the second sealed edge comprises a curled seal.

20. The collapsible cushion bag of claim 17, wherein each of the first portions of the first sealed edge and the second sealed edge comprises an overseal.

21. The collapsible cushion bag of claim 17, wherein each of the second portions of the first sealed edge and the second sealed edge is weakened.

22. A method of manufacturing a collapsible cushion bag, comprising:
a. mating a first rectangular sheet to a second rectangular sheet;
b. sealing a first side edge of the first rectangular sheet to a first side edge of the second rectangular sheet to form a first sealed side edge;
c. sealing a second side edge of the first rectangular sheet to a second side edge of the second rectangular sheet to form a second sealed side edge,
d. sealing a bottom edge of the first rectangular sheet with a bottom edge of the second rectangular sheet, thereby forming a bag having a top opening and a closed bottom, the bag defining a first bottom corner and a second bottom corner; and
e. compromising a portion of each bottom corner, wherein the collapsible cushion bag is formed.

23. The method of claim 22, wherein the sealing step comprises:
a. providing a sealing platform comprising two sealing areas, each curved sealing area operatively associated with a curved sealer; and
b. placing the mated first and second rectangular sheets on the sealing platform, wherein the first side edges and the second side edges are in between their respective curved seal areas and their respective curved sealers;
c. rolling the curved sealers through their respective curved seal areas on top of their respective first and second sides,
d. thereby creating a curved seal at the first and second side edges.

24. The method of claim 22, wherein the portion of each bottom corner is compromised with a press.

25. The method of claim 22, further comprising trimming a portion of the first and second sealed edges, each trimmed portion being adjacent to one of the compromised bottom corners.

26. The method of claim 22, wherein compromising the bottom corners comprises cutting-out the bottom corners.

27. The method of claim 22, perforating the closed bottom at a peripheral bottom edge to create a perforated attachment between the first and second mated rectangular sheet portions and a third and fourth mated rectangular sheet portions, wherein tearing the perforated attachment creates the top opening of the bag.

28. A method of using a collapsible cushion bag, comprising:
a. providing a collapsible cushion bag comprising
i. a first side and a second side adjacent to the first side, the first and second sides attached to each other at a first sealed side edge and a second sealed side edge opposite the first sealed side edge, thereby forming a top opening,
ii. a closed bottom edge opposite the top opening and adjacent to the two side sealed side edges, and
iii. two compromised bottom corners opposite each other and adjacent to the two sealed side edges, respectively, and adjacent to the closed bottom edge;
b. collapsing the compromised bottom corners by applying a force on the two sealed side edges and an opposing force on the closed bottom edge, wherein the closed bottom edge moves towards the top opening and the first and second sides move in opposite directions, wherein a bottom portion of the first side and second side bend to form a flat bottom, a first side portion of the first and second sides bend to form a third side, and a second side portion of the first and second sides bend to form a fourth side opposite the third side, thereby forming a box-like configuration.

29. The method of claim 28, further comprising sealing the third side to the flat bottom and sealing the fourth side to the flat bottom.
